(19) United States
(12) Patent Application Publication
(10) Pub. No.: US 2020/0369222 A1
(43) Pub. Date: Nov. 26, 2020

(54) AUTOMOTIVE SHEET INCLUDING MULTIPLE PATTERNS AND METHOD OF MANUFACTURING THE SAME

(71) Applicants: HYUNDAI MOTOR COMPANY, Seoul (KR); KIA MOTORS CORPORATION, Seoul (KR); LG Hausys, Ltd., Seoul (KR)

(72) Inventors: Jae Hyun AN, Seosan-si (KR); In Soo HAN, Uiwang-si (KR); Jae Hun WOO, Ulsan (KR); Jong Seok ROH, Seoul (KR); Yong Bae JUNG, Ulsan (KR)

(73) Assignees: HYUNDAI MOTOR COMPANY, Seoul (KR); KIA MOTORS CORPORATION, Seoul (KR); LG Hausys, Ltd., Seoul (KR)

(21) Appl. No.: 16/685,519

(22) Filed: Nov. 15, 2019

(30) Foreign Application Priority Data
May 21, 2019 (KR) 10-2019-0059454

(51) Int. Cl. B60R 13/02; B32B 27/08; B32B 27/32

(52) U.S. Cl. CPC B60R 13/02; B29C 39/42; B32B 27/322; B32B 27/08

(57) ABSTRACT

An automotive sheet including a plurality of polygonal unit patterns and a method of manufacturing the automotive sheet are disclosed. In particular, horizontal and vertical lengths of each unit pattern included in a pattern unit may be set in consideration of elongation of a curved sheet. The automotive sheet reduces distortion of the pattern and forms a uniform pattern size and shape, such that it is possible to improve the aesthetic appearance and the tactile sensation of the automotive sheet. In addition, an outer layer of the automotive sheet is formed through vacuum molding, such as IMG molding, after which multiple patterns may be coated and printed to manufacture the automotive sheet. In the method of manufacturing the automotive sheet, therefore, time and cost are reduced compared to other methods, such as a cloth wrapping method, whereby economic efficiency is improved.

### CROSS-REFERENCE TO RELATED APPLICATION

This application claims priority to and the benefit of Korean Patent Application No. 10-2019-0059454, filed on May 21, 2019, the entire contents of which are incorporated herein by reference.

### FIELD

The present disclosure relates to an automotive sheet including a plurality of polygonal unit patterns and a method of manufacturing the same.

### BACKGROUND

The statements in this section merely provide background information related to the present disclosure and may not constitute prior art.

In general, a sheet for automotive interior materials is made of PVC, TPO, PP, PE, PU, or cloth. In a recent trend, however, the automotive sheet is being rapidly replaced by a thermoplastic polyolefin-based elastomer (hereinafter, referred to as “TPO”) sheet, which is environmentally friendly, is lightweight, and is advantageous in terms of fogging and smell. In particular, advances in automotive interior materials have accelerated competitiveness as time goes by, and as the expectations of purchasers increase, interest in the development of interior materials satisfying the same has arisen.

In the case in which an automotive sheet is manufactured using a TPO sheet according to the above trend, it is general to realize the color of the automotive sheet using a simple color, such as black or gray. In the case in which the sheet is formed using TPO, however, the tactile sensation of the sheet is very smooth and the gloss of the sheet is excessive. As a result, consumers feel as if the sheet were made of plastic in many cases, whereby the aesthetic appearance of the sheet is deteriorated.

Meanwhile, an automotive sheet for a seating surface, a rear part, a crash pad, or a center console is curved so as to be suitable for the characteristics of the human body. In the case in which a sheet including multiple patterns is used for a curved portion, as shown in FIGS. 1A and 1B, it can be seen that the distortion of the patterns becomes severe.

We have discovered that since the upper part of a cluster of the crash pad is bent more in a portion having many curved surfaces, as shown in FIG. 2, the distortion of the multiple patterns included in the sheet on the upper part of the cluster of the crash pad becomes more severe.

That is, in the case in which a general pattern is included in a sheet having a curved surface, the general pattern is distorted in the direction in which the sheet extends, whereby the aesthetic appearance of the sheet for automotive interior materials is deteriorated.

The above information disclosed in this Background section is provided only for enhancement of understanding of the background of the present disclosure and therefore it may contain information that does not form the prior art that is already known to a person of ordinary skill in the art.

### SUMMARY

The present disclosure provides an automotive sheet having reduced distortion of multiple patterns, and an uniform size and shape of the multiple patterns in order to improve the aesthetic appearance and the tactile sensation of the automotive sheet.

The present disclosure provides an automotive sheet having no pattern distortion on a curved surface even when including a plurality of unit patterns.

It is another object of the present disclosure to provide a method of manufacturing an automotive sheet that is capable of reducing time and cost.

The objects of the present disclosure are not limited to those described above. The objects of the present disclosure will be clearly understood from the following description and could be implemented by means defined in the claims and a combination thereof.

In one aspect, the present disclosure provides an automotive sheet including: an outer layer and a print layer coated on the outer layer, wherein the print layer includes a pattern unit including a plurality of unit patterns, and the unit patterns are configured such that at least three unit patterns among the plurality of unit patterns are adjacent to each other in order to have a single contact point.

Each of the unit patterns may be formed in a polygonal shape having 10 sides or less.

Each of the unit patterns may be formed in a hexagonal shape.

The hexagonal shape may have an aspect ratio of 1.05 to 1.50.

Each of the unit patterns may be configured to have a color different from the color of an adjacent unit pattern.

The color may be selected from the group consisting of red, yellow, green, and a combination thereof.

The automotive sheet may further include a foam layer disposed under the outer layer.

In another aspect, the present disclosure provides a method of manufacturing an automotive sheet, the method including forming an outer layer and forming a print layer on the outer layer, wherein the print layer includes a pattern unit including a plurality of unit patterns, and the unit patterns are configured such that at least three unit patterns among the plurality of unit patterns are adjacent to each other in order to have a single contact point.

Each of the unit patterns may be formed in a polygonal shape having 10 sides or less.

Each of the unit patterns may be formed in a hexagonal shape.

The hexagonal shape may have an aspect ratio of 1.05 to 1.50.

Each of the unit patterns may be configured to have a color different from the color of an adjacent unit pattern.

The color may be selected from the group consisting of red, yellow, green, and a combination thereof.

The method may further include forming a foam layer under the outer layer.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the present disclosure are discussed infra.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1A and 1B are views showing examples in which, in the case in which a conventional sheet including multiple patterns is used for a curved portion, the patterns are distorted;

FIG. 2 is a view showing an example in which, in the case in which a conventional automotive sheet including multiple patterns is used as a crash pad, the patterns are distorted;

FIG. 3 is a sectional view schematically showing an automotive sheet including multiple patterns according to one form of the present disclosure;

FIG. 4 is a view showing the extent of distortion of a unit pattern according to another form of the present disclosure depending on the shape of the unit pattern;

FIG. 5 is a view showing the extent of distortion of a hexagonal unit pattern according to another form of the present disclosure due to a change in the horizontal/vertical length and the aspect ratio of the unit pattern;

FIG. 6A is a front view schematically showing an automotive sheet including multiple patterns according to another form of the present disclosure;

FIG. 6B is a view showing an example in which, even in the case in which an automotive sheet including multiple patterns according to another form of the present disclosure is used for a curved portion, the distortion of the patterns is reduced; and

FIG. 7 is a view showing a method of manufacturing an automotive sheet according to a further form of the present disclosure.

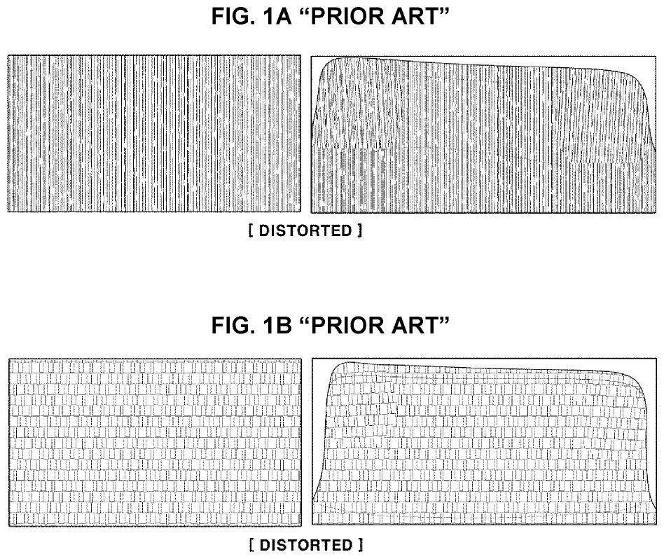

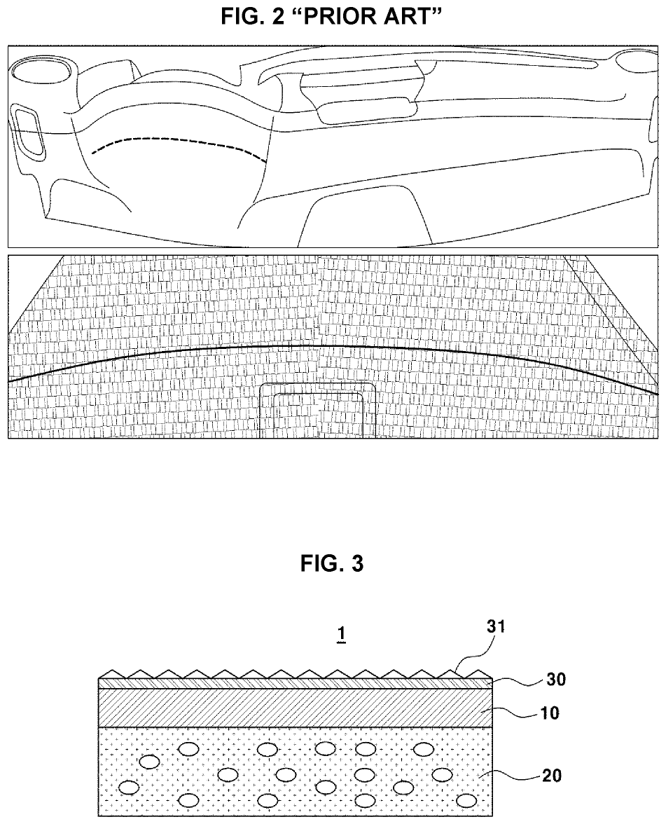

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The objects described above, and other objects, features and advantages will be clearly understood from the following exemplary forms with reference to the attached drawings. The forms are suggested only to offer thorough and complete understanding of the disclosed contents and sufficiently inform those skilled in the art of the technical concept of the present disclosure.

It should be understood that the appended drawings are not necessarily to scale, presenting a somewhat simplified representation of various formed features illustrative of the basic principles of the present disclosure. The specific design features of the present disclosure as disclosed herein, including, for example, specific dimensions, orientations, locations, and shapes, will be determined in part by the particular intended application and use environment.

It will be further understood that the terms “comprises”, “has” and the like, when used in this specification, specify the presence of stated features, numbers, steps, operations, elements, components or combinations thereof, but do not preclude the presence or addition of one or more other features, numbers, steps, operations, elements, components, or combinations thereof. In addition, it will be understood that, when an element such as a layer, film, region or substrate is referred to as being “on” another element, it can be directly on the other element or an intervening element may also be present. It will also be understood that, when an element such as a layer, film, region or substrate is referred to as being “under” another element, it can be directly under the other element or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures among other things. For this reason, it should be understood that, in all cases, the term “about” should modify all numbers, figures and/or expressions. In addition, when numeric ranges are disclosed in the description, these ranges are continuous and include all numbers from the minimum to the maximum including the maximum within the range unless otherwise defined. Furthermore, when the range refers to an integer, it includes all integers from the minimum to the maximum including the maximum within the range, unless otherwise defined.

The present disclosure relates to an automotive sheet including multiple patterns and a method of manufacturing the same. Even in the case in which the automotive sheet includes a plurality of unit patterns, distortion of the patterns on a curved surface is reduced. Consequently, the present disclosure provides an automotive sheet having a good aesthetic appearance.

FIG. 3 is a sectional view schematically showing an automotive sheet 1 according to one form of the present disclosure. Referring to FIG. 3, the automotive sheet includes an outer layer 10, a foam layer 20 located under the outer layer, and a print layer 30 coated on the outer layer, the print layer 30 including a pattern unit 31.

The automotive sheet 1 may be disposed at the front part of the interior of a vehicle, which constitutes a driver's seat and the seat next to the driver, such that various electronic devices necessary to drive the vehicle, an audio device, an air conditioner, an airbag device, etc. are mounted to the automotive sheet. In one form, the automotive sheet may be applied to a seating surface having a curved surface, a rear part, a crash pad, or a center console.

The outer layer 10 is not particularly restricted, as long as the outer layer is lightweight, is durable, and does not emit a smell, thereby being capable of serving as an interior material of a vehicle.

The outer layer may be made of thermoplastic olefin (TPO), polyvinyl chloride (PVC), polypropylene (PP), polyethylene (PE), plutonium (PU), or cloth. In addition, TPO may further include a PP resin, a PE resin, ethylene-octene rubber, or an inorganic filler.

The foam layer 20 is not particularly restricted, as long as the foam layer is flame-retardant, is flexible, is cushiony, and serves as a shock-absorbing material or a sealing material at the time of assembly of the vehicle.

The foam layer may be made of a thermoplastic polyurethane (TPU) resin, a polyvinyl chloride (PVC) resin, a polyvinylidene chloride (PVDC) resin, a polyvinylidene fluoride (PVDF) resin, a chlorinated polyvinyl chloride (CPVC) resin, a polyvinyl butyral (PVB) resin, a polyvinyl alcohol (PVA) resin, a polyvinyl acetate (PVAc) resin, TPO, a polypropylene (PP) resin, a polyurethane resin, a polystyrene resin, a polyethylene resin, or Hanaceran. A foam assistant, a bridge assistant, a phosphorus-based flame retardant, a melamine-based flame retardant, or a pentaerythritol-based additive may be further included in the foam material.

The print layer 30 is not particularly restricted, as long as the print layer is capable of improving pollution resistance, stain resistance, and slip performance, is capable of reducing or minimizing frictional noise, and includes a pattern unit including a plurality of unit patterns.

The print layer may be formed using an offset printing method, a flexographic printing method, a screen printing method, or a gravure roll printing method. In another form, the gravure roll printing method is used.

The material for the print layer may include a coloring agent including a dye and a pigment, a vehicle including oil and fat, a resin, or solvent, and an assistant. In the offset printing method, the vehicle, obtained by combining a synthetic resin, drying oil, a high boiling solvent, may be used. In the flexographic printing method, flexographic ink including an aqueous or alcohol-type resin may be used. In the gravure roll printing method, evaporation-type rapid drying ink may be used.

Particularly, in the gravure roll printing method, printing may be performed using aqueous ink or oil ink. An inorganic pigment such as barium sulfate or calcium carbonate, an organic pigment such as an insoluble azo-based pigment or a soluble azo-based pigment, a natural resin or a derivative thereof, a synthetic resin, alcohol, ester, ketone, an alcohol inducer, (aromatic or aliphatic) hydrocarbon, or an assistant such as a plasticizer or an antioxidant may be included depending on the properties of the ink.

The print layer includes a pattern unit 31 including a plurality of unit patterns. The unit patterns included in the pattern unit may be made of a material identical to or different from the material for the print layer.

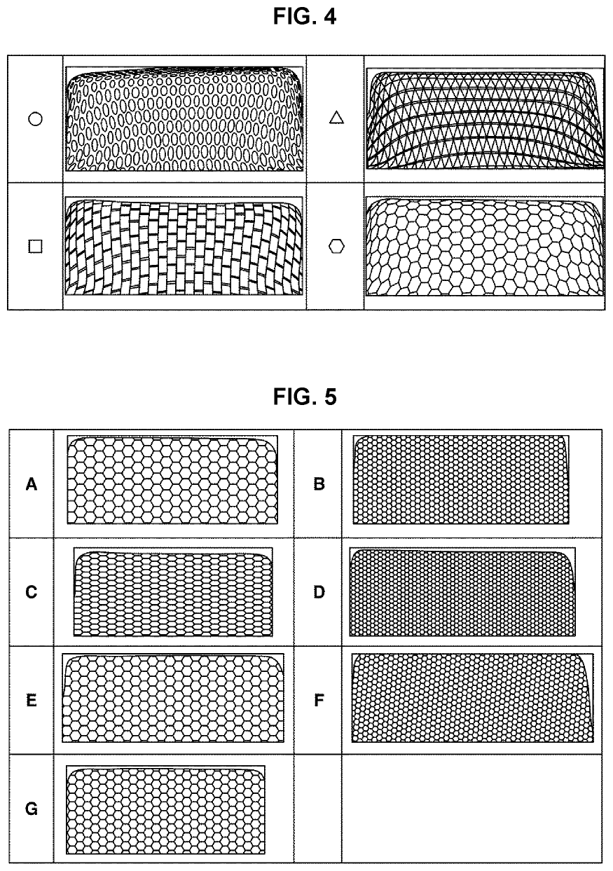

FIG. 4 is a view showing the extent of distortion of a unit pattern according to one form of the present disclosure depending on the shape of the unit pattern. In addition, Table 1 below is a table showing the aspect ratios of various shapes of the unit pattern before and after molding using a test mold according to one form of the present disclosure.

TABLE 1

| | Before molding | | | After molding | | | | |
|---|---|---|---|---|---|---|---|---|
| | | | Aspect | | | | | Aspect |
| | Horizontal | Vertical | ratio | Horizontal | Horizontal | Vertical | Vertical | ratio |
| 3 faces | length | length | (horizontal) | length | elongation | length | elongation | (horizontal) |
| Circular | 2.5 | 2.5 | 1.00 | 2.93 | 17.2% | 4.43 | 77.2% | 0.34 |
| Triangular | 2.5 | 2.5 | 1.00 | 3.06 | 22.4% | 4.17 | 66.8% | 0.33 |
| Quadrangular | 2.5 | 2.5 | 1.00 | 3.15 | 26.0% | 4.63 | 85.2% | 0.32 |
| Hexagonal | 3.75 | 2.5 | 1.50 | 4.37 | 16.5% | 4.35 | 74.0% | 1.00 |

The aspect ratio is the ratio of the horizontal length to the vertical length of the unit pattern. In the present disclosure, the horizontal length may be based on the longitudinal direction of the vehicle, and the vertical length may be the widthwise direction of the vehicle. In the present disclosure, the distortion of the pattern is reduced as the aspect ratio of the pattern after molding approximates 1.0.

The horizontal/vertical elongation is the percentage of the increased length to the original horizontal/vertical length in the case in which the horizontal/vertical length of the unit pattern is increased due to extension of the automotive sheet. The horizontal/vertical length of the unit pattern is set by the elongation. The range of the elongation may be 0 to 250%.

Referring to FIG. 4 and Table 1, first, the vertical length of each of unit patterns having different shapes before molding was equally set to 2.5. Subsequently, automotive sheets including a plurality of unit patterns having different shapes were stretched. As a result, it can be seen that the aspect ratio of the circular shape was 0.34, the aspect ratio of the triangular shape was 0.33, the aspect ratio of the quadrangular shape was 0.32, and the aspect ratio of the hexagonal shape was 1.00. That is, it can be seen that the aspect ratio of the hexagonal unit pattern after molding was 1.00, and therefore the distortion of the hexagonal unit pattern was reduced the most.

As a result, it can be seen that, in the case in which the shape of the unit pattern is hexagonal, the aspect ratio of the hexagonal unit pattern after molding is 1.00, and therefore the distortion of the hexagonal unit pattern is reduced more in numerical value than the unit patterns having different shapes and that the distortion of the hexagonal unit pattern is the smallest, even when observed with the naked eye.

Consequently, the unit patterns according to one form of the present disclosure may be configured such that at least three unit patterns are adjacent to each other in order to have a single contact point. In one form, the unit pattern is formed in a polygonal shape having 10 sides or less. In another form, the unit pattern is formed in a hexagonal shape.

The contact point is a point at which a straight line and another straight line are joined to each other. In one form, the contact point is a point or an apex at which at least two common sides of adjacent unit patterns are joined to each other. In addition, the contact point may be a point or an apex at which at least two common sides of adjacent polygons having 10 sides or less are joined to each other. In another form, the contact point is a point or an apex located at the position at which three common sides of at least three adjacent unit patterns face each other.

FIG. 5 is a view showing the extent of distortion of the hexagonal unit pattern according to one form of the form of the present disclosure due to a change in the horizontal/vertical length and the aspect ratio of the unit pattern.

In addition, Table 2 below is a table showing the aspect ratio of the hexagonal unit pattern according to one form of the present disclosure based on the horizontal/vertical length before and after molding using a test mold due to a change in the horizontal/vertical length and the aspect ratio of the unit pattern.

TABLE 2

| | Before molding | | | After molding | | | | |
|---|---|---|---|---|---|---|---|---|
| | | | Aspect | | | | | Aspect |
| | Horizontal | Vertical | ratio | Horizontal | Horizontal | Vertical | Vertical | ratio |
| 3 faces | length | length | (horizontal) | length | elongation | length | elongation | (horizontal) |
| A | 3.75 | 2.5 | 1.50 | 4.37 | 16.5% | 4.35 | 74.0% | 1.00 |
| B | 1.88 | 2.5 | 0.75 | 2.84 | 51.1% | 3.86 | 54.4% | 0.74 |
| C | 3.75 | 1.25 | 3.00 | 3.97 | 5.9% | 2.53 | 102.4% | 1.57 |
| D | 1.88 | 1.25 | 1.50 | 2.13 | 13.3% | 2.43 | 94.4% | 0.88 |
| E | 2.63 | 2.5 | 1.05 | 4.29 | 63.1% | 3.24 | 29.6% | 1.32 |
| F | 3.75 | 1.75 | 2.14 | 4.46 | 18.9% | 3.31 | 89.1% | 1.35 |
| G | 2.63 | 1.75 | 1.50 | 3.1 | 17.9% | 3.64 | 108.0% | 0.85 |

Referring to FIG. 5 and Table 2, it can be seen in the aspect ratio after molding that the aspect ratio of A was 1.50, and therefore the distortion of the unit pattern was reduced the most. In addition, it can be seen from the determination of the horizontal/vertical length and the extent of distortion of the unit pattern after molding that the aspect ratios of D, E, and G were 1.50, 1.05, and 1.50, respectively, which was the optimum ratio capable of reducing distortion. Consequently, it can be seen that the optimum aspect ratio at which distortion is not apparent in the test mold ranges from 1.05 to 1.50.

Meanwhile, even in the case of the same aspect ratio (A, D, and G), it can be seen that A (having a horizontal length of 3.75 mm and a vertical length of 2.5 mm), D (having a horizontal length of 1.88 mm and a vertical length of 1.25 mm), and G (having a horizontal length of 2.63 mm and a vertical length of 1.75 mm) have different horizontal lengths and vertical lengths. Even in the case in which the optimum aspect ratio is 1.50, therefore, it can be seen that the distortion of a hexagonal unit pattern having a horizontal length of 1.88 to 3.75 mm and a vertical length of 1.25 to 2.5 mm is reduced the most when extended.

In addition, Table 3 below is a table showing the aspect ratio based on elongation through molding of an actual product according to one form of the present disclosure.

TABLE 3

| | | | | | Aspect |
|---|---|---|---|---|---|
| | Horizontal | Horizontal | Vertical | Vertical | ratio |
| | length | elongation | length | elongation | (horizontal) |
| Before | 1.26 | — | 1.01 | — | 1.25 |
| molding | | | | | |
| After | 1.35 | 7.1% | 1.82 | 80.2% | 0.74 |
| molding | | | | | |
| 2 (cluster | | | | | |
| portion) | | | | | |
| After | 1.3 | 3.2% | 1.15 | 13.9% | 1.13 |
| molding | | | | | |
| 4 (PAB) | | | | | |

Referring to Table 3, it can be seen that, when an actual product is molded, the aspect ratio is 0.8 to 1.2 in the case in which the required elongation is 10% or less, and the aspect ratio is 0.6 to 1.4 in the case in which the required elongation is 80 to 100%.

After considering the above, the aspect ratio of the hexagonal unit pattern including all of the above conditions according to one form of the present disclosure may be 0.7 to 1.4, preferably 1.05 to 1.50. Even in the case in which the aspect ratio is 1.50, the horizontal length may be 1.88 to 3.75 mm, and the vertical length may be 1.25 to 2.5 mm. In addition, the aspect ratio may be changed depending on elongation.

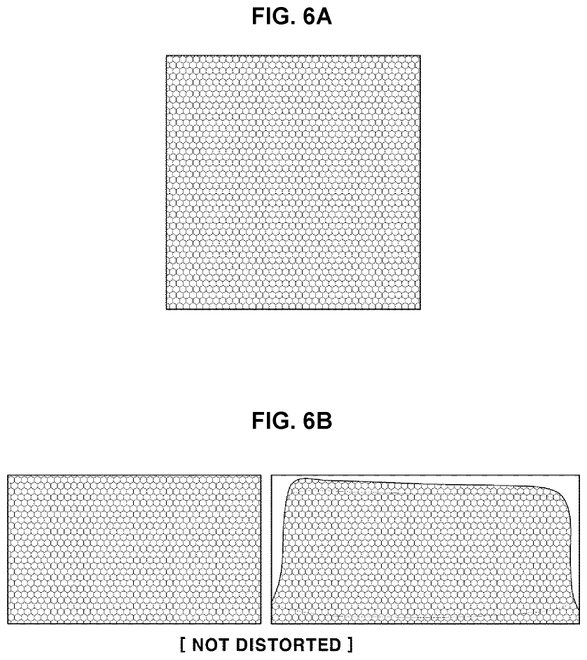

FIG. 6A is a front view showing a plurality of printed unit patterns of an automotive sheet according to one form of the present disclosure. In addition, FIG. 6B is a view showing an example in which the distortion of unit patterns of a curved automotive sheet according to one form of the present disclosure is reduced. Referring to FIGS. 6A and 6B, in the case in which the automotive sheet is molded after the horizontal/vertical length is set in consideration of the required elongation, it can be seen that the distortion of the pattern on the curved surface of the automotive sheet is reduced, whereby the aesthetic appearance thereof is improved.

In addition, the unit pattern may be configured to have a color different from the color of an adjacent unit pattern in order to improve the aesthetic appearance thereof.

In one form, the color is selected from the group consisting of red, yellow, green, and a combination thereof.

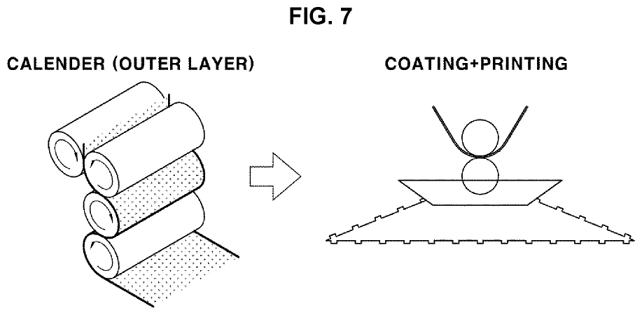

FIG. 7 is a view showing a method of manufacturing the automotive sheet 1 according to another form of the present disclosure.

Referring to this figure, the manufacturing method may include a step of forming an outer layer (S10) and a step of forming a print layer including a pattern unit on the outer layer (S20), and may further include a step of forming a foam layer under the outer layer (S30).

The manufacturing method according to the present disclosure is not a method of manufacturing an outer layer and then forming a pattern layer through a cloth wrapping process, i.e. forming a plurality of layers, but is a method of coating and printing a single print layer including a pattern unit on the outer layer.

At the step of forming the outer layer (S10), the outer layer may be formed using an injection molding method and a vacuum molding method. Specifically, the injection molding method is a method of injecting a material into a mold to form a product. In addition, the vacuum molding method is a method of heating a thermoplastic plate or pile at a surface temperature of about 130 to 140° C., pushing a molding frame toward the sheet, suctioning the air between the frame and the sheet in order to form a vacuum, bringing the sheet into tight contact with the surface of the frame in order to cool and solidify the sheet, and removing the sheet.

In the present disclosure, the vacuum molding method may be used, and in another form, an in-mold grain (IMG) vacuum molding method is used.

The IMG vacuum molding method, which may be used in the present disclosure, is a method of suctioning an outer layer in a vacuum in the state in which a molding frame is attached and transferring an embossed portion formed on the molding frame to the outer layer in order to form the embossed portion on the surface of a raw material while forming the outer layer in the shape of an automotive interior material.

At the step of forming the print layer including the pattern unit on the outer layer (S20), the print layer may be formed using an offset printing method, a flexographic printing method, a screen printing method, or a gravure roll printing method. In one form, the print layer is formed using the gravure roll printing method.

The gravure roll printing method is a method of filling concave portions formed in a gravure cylinder with ink and applying pressure to the gravure cylinder using an impression roller to imprint the ink on the outer layer 10.

In the gravure roll printing method, a plate gravure press or a rotary gravure press may be used depending on the shape of a printing plate, or an individual sheet-type gravure press or a roll-type gravure press may be used depending on a paper feeding mode.

In addition, a pattern unit according to an exemplary form of the present disclosure may be formed using the gravure roll printing method or other different methods.

The pattern unit formed using the gravure roll printing method may be formed on the print layer, and includes a plurality of unit patterns.

Each of the unit patterns may be printed in a hexagonal shape, at which the distortion of the pattern is the most reduced when the sheet is extended on a curved surface. The unit patterns may be printed on the print layer in the state in which the aspect ratio of the hexagonal shape is 1.05 to 1.50, at which the distortion of the pattern is the most reduced. Among unit patterns each having the aspect ratio of 1.50, which may become 1.0 after molding, however, a unit pattern having a horizontal length of 1.88 to 3.75 mm and a vertical length of 1.25 to 2.5 mm may be printed.

Since the horizontal and vertical lengths of the unit pattern according to the form of the present disclosure may be set in consideration of elongation of the curved sheet, therefore, it is possible to reduce the distortion of the pattern when the sheet is extended, whereby it is possible to print a plurality of unit patterns so as to have a uniform pattern size and shape.

Also, in order to improve the aesthetic appearance thereof, a dye or a pigment may be added to an ink material to form red, yellow, green, or a combination thereof, and printing may be performed such that adjacent unit patterns have different colors.

In addition, a process of forming an embossed portion on the pattern unit depending on the shape thereof even after the print layer including the pattern unit is printed may be further included.

The method of manufacturing the automotive sheet according to the present disclosure may further include the step of forming the foam layer under the outer layer (S30).

The foam layer may be formed using a thermoplastic polyurethane (TPU) resin, a polyvinyl chloride (PVC) resin, a polyvinylidene chloride (PVDC) resin, a polyvinylidene fluoride (PVDF) resin, a chlorinated polyvinyl chloride (CPVC) resin, a polyvinyl butyral (PVB) resin, a polyvinyl alcohol (PVA) resin, a polyvinyl acetate (PVAc) resin, TPO, a polypropylene (PP) resin, apolyurethane resin, or a polystyrene resin.

For example, in the case in which the polyurethane resin is used, the foam layer may be formed of a polymer material containing a urethane bond generated by polyol and isocyanate through a reaction between NCO of isocyanate and a hydroxyl group (OH) of polyol. In addition, a physical foaming agent having a chemical foaming agent added thereto or a general physical foaming agent, such as CFC-11, HCFC-141b, HFC-245fa, or other pentanes, may be used during the foaming process.

Also, in the case in which TPO is used, a chemical foaming agent or a capsule foaming agent may be introduced into TPO, and the same may be foamed during the production process in order to manufacture a foam TPO layer.

As is apparent from the foregoing, according to the present disclosure, the horizontal and vertical lengths of each unit pattern included in a pattern unit are set in consideration of the elongation of a curved sheet, and therefore it is possible to form an automotive sheet having reduced distortion of the pattern and a uniform pattern size and shape, whereby it is possible to improve the aesthetic appearance and the tactile sensation of the automotive sheet.

In addition, according to the present disclosure, an outer layer is formed through vacuum molding, such as IMG molding, and then multiple patterns are coated and printed to manufacture an automotive sheet. In a method of manufacturing an automotive sheet according to the present disclosure, therefore, time and cost are reduced compared to other methods, such as a cloth wrapping method, whereby economic efficiency is improved.

The effects of the present disclosure are not limited to those mentioned above. It should be understood that the effects of the present disclosure include all effects that can be inferred from the foregoing description of the present disclosure.

The present disclosure has been described in detail with reference to the exemplary forms thereof. However, it will be appreciated by those skilled in the art that changes may be made in these forms without departing from the principles and spirit of the present disclosure.

What is claimed is:

1. An automotive sheet comprising:
an outer layer; and
a print layer coated on the outer layer,
wherein the print layer comprises a pattern unit comprising a plurality of unit patterns, and
the plurality of unit patterns are configured such that at least three unit patterns among the plurality of unit patterns are adjacent to each other so as to have a single contact point.

2. The automotive sheet according to claim 1, wherein each unit pattern of the plurality of unit patterns is formed in a polygonal shape having ten sides or less.

3. The automotive sheet according to claim 1, wherein each unit pattern of the plurality of unit patterns is formed in a hexagonal shape.

4. The automotive sheet according to claim 3, wherein the hexagonal shape has an aspect ratio of 1.05 to 1.50.

5. The automotive sheet according to claim 1, wherein each unit pattern of the plurality of unit patterns is configured to have a color different from a color of an adjacent unit pattern.

6. The automotive sheet according to claim 5, wherein the color is selected from a group consisting of red, yellow, green, and a combination thereof.

7. The automotive sheet according to claim 1, further comprising a foam layer disposed under the outer layer.

8. A method of manufacturing an automotive sheet, the method comprising:
forming an outer layer; and
forming a print layer on the outer layer,
wherein the print layer comprises a pattern unit comprising a plurality of unit patterns, and
the plurality of unit patterns are configured such that at least three unit patterns among the plurality of unit patterns are adjacent to each other so as to have a single contact point.

9. The method according to claim 8, wherein each unit pattern of the plurality of unit patterns is formed in a polygonal shape having ten sides or less.

10. The method according to claim 8, wherein each unit pattern of the plurality of unit patterns is formed in a hexagonal shape.

11. The method according to claim 10, wherein the hexagonal shape has an aspect ratio of 1.05 to 1.50.

12. The method according to claim 8, wherein each unit pattern of the plurality of unit patterns is configured to have a color different from a color of an adjacent unit pattern.

13. The method according to claim 12, wherein the color is selected from a group consisting of red, yellow, green, and a combination thereof.

14. The method according to claim 8, further comprising forming a foam layer under the outer layer.
